(19) United States
(12) Patent Application Publication
(10) Pub. No.: US 2010/0127415 A1
(43) Pub. Date: May 27, 2010

(54) METHOD FOR PREPARING POLYUREA MICROCAPSULE CONTAINING SATURATED ALCOHOL DISPERSION MEDIUM, AND MICROCAPSULE PREPARED USING THE METHOD

(75) Inventors: Chul-Am Kim, Seoul (KR); In-Kyu You, Daejeon (KR); Kyung-Soo Suh, Daejeon (KR); Seung-Youl Kang, Daejeon (KR); Ji-Eun Jung, Daejeon (KR); Ji-Young Oh, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/495,596

(22) Filed: Jun. 30, 2009

(30) Foreign Application Priority Data
Nov. 25, 2008 (KR) 10-2008-0117467

(51) Int. Cl. B01J 13/18

(52) U.S. Cl. 264/4.7

(57) ABSTRACT

Provided are a method for forming polyurea microcapsules containing a saturated alcohol as a dispersion medium, and microcapsules prepared using the method. According to the method, suspensions, in which microcapsules are dispersed in a saturated alcohol dispersion medium as a core material, may be used to prepare microcapsules. Diverse and fine color expression may be obtained from various response characteristics in the display applications. In addition to superior processibility, excellent thermal stability, solvent resistance, and chemical stability may be achieved by using polyurea in microcapsules as a wall material according to one embodiment of the present invention.

### CROSS-REFERENCE TO RELATED APPLICATIONS

This U.S. non-provisional patent application claims priority under 35 U.S.C. §119 of Korean Patent Application No. 10-2008-0117467, filed on Nov. 25, 2008, the entire contents of which are hereby incorporated by reference.

### BACKGROUND OF THE INVENTION

The present invention disclosed herein relates to a method for forming microcapsules, and more particularly, to a method for forming polyurea microcapsules containing a saturated alcohol dispersion medium, and microcapsules formed using the method.

The term “microcapsules” refers to an encapsulation of liquid, solid, or gas molecules into a container (cell) which is fine up to hundreds of micrometers. An important function of a microcapsule is its storability or processibility, to protect encapsulated contents from damage or degradation, or separate contents from other materials not to be reacted with, for example.

Microencapsulation involves selecting a desired material from various liquid, solid, and gaseous materials, or a mixture thereof, as a core material and applying the material in various industries, including display products, adhesives, pesticides, flavors, cosmetics and pharmaceuticals.

In particular, microencapsulation that adopts suspensions (such as one in which conductive polymers are dispersed in a dispersion medium such as water or oil) as a core material may be applied in various display fields, including electronic paper, liquid crystal displays, and suspended particle displays (SPD). In display fields, response characteristics of dispersed particles may differ depending on the kind of dispersion medium in the core material of a microcapsule, and thus, wavelengths of light emitted from display devices may differ.

Because typical microcapsules used as dispersion media for core materials in display fields are usually limited to non-polar organic solvents, response characteristics of dispersed particles tend to be limited in scope. This is mainly because microcapsules are produced when water and an immiscible non-polar organic solvent are mixed and stirred to form emulsions. That is, two immiscible phase fluids are required to produce microcapsules, and the representative two immiscible phase fluids are water and oil (a non-polar organic solvent). For these reasons, there are limitations to how many types of dispersion media can be used, and also limitations to the response characteristics of dispersed particles, which may inhibit diverse and fine color expression in display devices.

### SUMMARY OF THE INVENTION

The present invention provides a method for forming microcapsules which may provide various wavelength characteristics by using a new material, instead of water and a non-polar organic solvent, as a dispersion medium, and microcapsules prepared using the method.

The present invention also provides a method for forming microcapsules that are highly thermally and chemically stable, and microcapsules formed using the method.

Embodiments of the present invention provide methods for forming microcapsules, including dispersing microparticles in a saturated alcohol to prepare suspensions; dissolving an amine-based monomer in the suspensions; mixing and stirring at least one selected from a vegetable oil and diesel oil with the suspensions to make emulsions; and dissolving a non-polar isocyanate compound in the emulsions to prepare microcapsules having the suspensions as a core material.

In some embodiments, the microparticles may include at least one selected from the group consisting of conductive particles, metal particles, organometallic particles, metal oxide particles, magnetic particles, and hydrophobic polymer particles.

In other embodiments, the saturated alcohol may be at least one selected from the group consisting of methanol, ethanol, propargyl alcohol (C₃H₄O), aryl alcohol (C₃H₆O), propanol (C₃H₈O), glycerol, butanol, and alcohols having a dielectric constant ranging from 17 to 33.

In still other embodiments, the dispersing of the microparticles in the saturated alcohol to prepare suspensions may comprise adding a dispersion stabilizer into the saturated alcohol.

In even other embodiments, the dispersion stabilizer may be a surfactant or a hydrophilic polymer.

In yet other embodiments, the amine-based monomer may be at least one selected from the group consisting of ethylenediamine (H₂NCH₂CH₂NH₂), triethylenetetramine (NH₂CH₂CH₂(NHCH₂CH₂)₂NH₂), piperazine, 1,6-hexamethylenediamine (H₂N—(CH₂)₆—NH₂), diethylenetetramine ((NH₂CH₂CH₂)₂NH), and polyethyleneimine (H(NHCH₂CH₂)nNH₂).

In further embodiments, the vegetable oil may be at least one selected from the group consisting of canola oil, corn oil, sunflower seed oil, grape seed oil, and olive oil.

In still further embodiments, the non-polar isocyanate compound may be at least one selected from the group consisting of 2,4-tolylene diisocyanate (TDI), 4,4′-diphenylmethane diisocyanate (MDI), hexamethylene diisocyanate (HDI), and methylene bis(p-cyclohexyl isocyanate (H₁₂MDI).

In even further embodiments, in the mixing and stirring of the suspensions with the at least one selected from the vegetable oil and diesel oil to make emulsions, the at least one selected from a vegetable oil and diesel oil may be mixed at a volume ratio of from 5:1 to 10:1 with the suspensions.

In other embodiments of the present invention, microcapsules include suspensions as a core material, in which microparticles are dispersed in a saturated alcohol, and polyurea as a wall material.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a flow chart illustrating a method for forming polyurea microcapsules containing a saturated alcohol medium according to one embodiment of the present invention;

FIG. 2 is a cross-sectional view of a microcapsule prepared according to one embodiment of the present invention; and

FIG. 3 is a light-microscopic photograph of microcapsules prepared in one Experimental Example of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

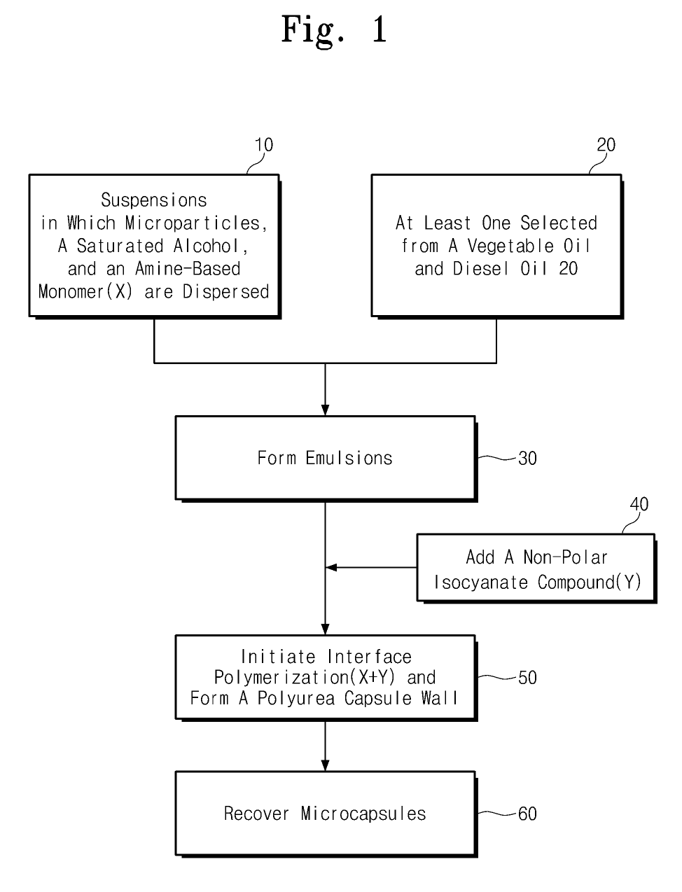

FIG. 1 is a flow chart illustrating a method for forming polyurea microcapsules containing a saturated alcohol medium in one embodiment of the present invention.

Referring to FIG. 1, a method for forming microcapsules in the present embodiment includes dispersing microparticles in a saturated alcohol to prepare suspensions and dissolving an amine-based monomer (X) in the suspensions (Step 10). The microparticles may include at least one selected from the group consisting of conductive particles, metal particles, organometallic particles, metal oxide particles, magnetic particles, and hydrophobic polymer particles. The microparticles may be dispersed in an amount of 0.1% to 10% by volume, based on the volume of the dispersion medium. The saturated alcohol may be at least one selected from the group consisting of methanol, ethanol, propargyl alcohol (C₃H₄O), aryl alcohol (C₃H₆O), propanol (C₃H₈O), glycerol, butanol, and alcohols with a dielectric constant range of 17-33. The amine-based monomer (X) may be at least one selected from the group consisting of ethylenediamine (H₂NCH₂CH₂NH₂), triethylenetetramine (NH₂CH₂CH₂(NHCH₂CH₂)₂NH₂), piperazine, 1,6-hexamethylenediamine (H₂N—(CH₂)₆—NH₂), diethylenetetramine ((NH₂CH₂CH₂)₂NH), and polyethyleneimine (H(NHCH₂CH₂)nNH₂). A dispersion stabilizer may be further added into the suspensions. A surfactant or a hydrophilic polymer may be used as the dispersion stabilizer. The suspensions may be prepared by using an ultrasonic homogenizer or a homogenizer.

Subsequently, at least one selected from a vegetable oil and diesel oil (of Step 20), and the suspensions (of Step 10) are mixed and stirred to form emulsions (of Step 30). In the mixing and stirring of the at least one selected from a vegetable oil and diesel oil with the suspensions to form emulsions, the at least one selected from a vegetable oil and diesel oil may be mixed at a volume ratio of from 5:1 to 10:1 with the suspensions. An emulsion stabilizer may be further added into the emulsion. For example, Span 85 may be used as the emulsion stabilizer. In the emulsions, the at least one selected from a vegetable oil and diesel oil (of Step 20) may adopt a continuous phase, and the suspensions (of Step 10) may adopt a dispersed phase. In the step, the dispersions may be slowly added into the continuous phase to minimize the formation of bubbles and form emulsions, and the time for emulsion formation may preferably be within 5 minutes. The vegetable oil may be at least one selected from the group consisting of canola oil, corn oil, sunflower seed oil, grape seed oil, and olive oil. The vegetable oil is a highly viscous fluid with a viscosity of 500 mPa or less, and requires a greater amount of supplied energy in emulsification (when emulsions are formed) than when a common solvent such as water is used in the continuous phase to produce emulsions. The diesel oil may be added into the vegetable oil as a viscosity modifier in order to control the diameter of emulsions (and control the microcapsule diameter as a result) produced in emulsification. The less the viscosity increase in the continuous phase, the greater the diameter increase of emulsions may be.

Subsequently, a non-polar isocyanate compound (Y) is slowly added into the continuous phase (Step 40), dissolved, and stirred at a set reaction temperature, preferably, for 30 minutes to 1 hour to initiate interfacial polymerization between the amine-based monomer (X) and the non-polar isocyanate compound (Y). Thus, the suspensions (of Step 10) and polyurea are used as a core material and a wall material, respectively, to prepare microcapsules (Step 50). The non-polar isocyanate compound (Y) may be at least one selected from the group consisting of 2,4-tolylene diisocyanate (TDI), 4,4′-diphenylmethane diisocyanate (MDI), hexamethylene diisocyanate (HDI), and methylene bis(p-cyclohexyl isocyanate (H₁₂MDI). After the interfacial polymerization is completed, the microcapsules are separated and recovered (Step 60) by using a method such as filtering or centrifugation. In addition, the capsules are washed with a mixture of a vegetable oil and diesel oil to remove unreacted non-polar monomers stuck on the wall surface of the capsules.

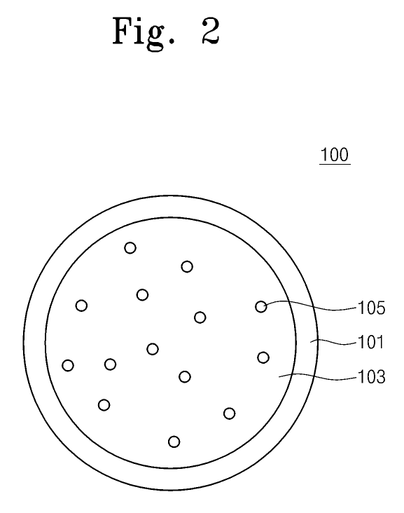

The microcapsule 100 formed by the method disclosed in FIG. 1 may be depicted as in FIG. 2. Referring to FIG. 2, the microcapsule 100 formed in the present embodiment contains a saturated alcohol 103, in which the micropaticles 105 are dispersed in the polyurea capsule wall 101, as a core material. The microcapsule 100 may have an effective diameter of, for example, 30 μm to 200 μm.

### EXPERIMENTAL EXAMPLE 1

### Preparation of Microcapsules Prepared Using Suspensions in Which Silica Particles are Dispersed in Ethanol

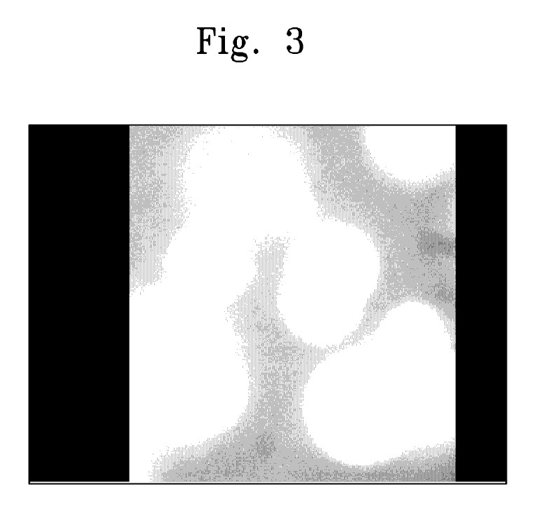

Silica particles with an average diameter of 100 nm or less were added into 45 ml of ethanol until the ratio reached 10% by weight, and the mixture was stirred in an ultrasonic homogenizer for 10 minutes to prepare suspensions in which alcohol particles are dispersed. After dispersion of silica particles, 5 g of polyethyleneimine (PEI) with the molecular weight of 1000 was added and dissolved into the suspensions to prepare a core material in the microcapsule. For continuous phase preparation, 300 ml of a non-polar continuous phase 9:1 ratio of canola oil and diesel oil was injected into a 1000 ml double-jacket reactor, and 0.6 ml of Span 85 was added as an emulsion stabilizer, while the reaction temperature was kept at room temperature. The suspensions were slowly added into the continuous phase and stirred at 200 rpm to form emulsions containing ethanol (a kind of polar organic solvent), canola oil (a kind of non-polar organic solvent), and diesel oil. After the mixture was stirred for 5 minutes to stabilize the produced emulsions, 5 ml of TDI was injected into the reaction system to initiate polymerization at the interface of the emulsions while maintaining the stirring state. An encapsulation reaction was maintained for 30 minutes, and then 500 ml of diesel oil was added to terminate the reaction. Microcapsules were recovered, and then washed with a mixture of canola oil/diesel oil (50/50% by volume) three times to obtain final microcapsules. FIG. 3 is a light-microscopic picture of microcapsules thus produced with suspensions in which silica particles are dispersed.

### EXPERIMENTAL EXAMPLE 2

### Preparation of Microcapsules Using Suspensions, in Which Silica Particles are Dispersed in Ethanol, and Canola Oil as a Reaction Mixture

Polarized particle suspensions were prepared using the same method as in Experimental Example 1. Silica particles with an average diameter of 100 nm or less were added into 45 ml of ethanol until the ratio reached 10% by weight, and the mixture was stirred in an ultrasonic homogenizer for 10 minutes to prepare suspensions in which alcohol particles are dispersed. After dispersion of silica particles, 5 g of polyethyleneimine (PEI) with the molecular weight of 1000 was added and dissolved into the suspensions to prepare a core material in the microcapsule. To prepare a continuous phase, 300 ml of canola oil was injected into a 1000 ml doublejacket reactor and 0.6 ml of Span 85 was added, while the reaction temperature was kept at room temperature. The suspensions were slowly added into the continuous phase and stirred at 200 rpm to form emulsions containing ethanol (a kind of polar organic solvent) and canola oil (a kind of non-polar organic solvent). After the mixture was stirred for 5 minutes to stabilize the produced emulsions, 5 ml of TDI was injected into the reaction system to initiate polymerization at the interface of the emulsions while maintaining the stirring state. An encapsulation reaction was maintained for 30 minutes, and then 500 ml of diesel oil was added to terminate the reaction. Microcapsules were recovered, and then washed with a mixture of canola oil/diesel oil (50/50% by volume) three times to obtain final microcapsules.

As described above, polyurea microcapsules may be prepared containing a saturate alcohol as a dispersion medium in the present invention. Considering that the saturated alcohol is a polar organic solvent and the vegetable oil and diesel oil are non-polar organic solvents, the present invention also provides oil-in-oil emulsion ability and variety and the variety of microencapsulations. In addition, the present invention may provide means to maximize the step of utilizing suspensions in which polar particles such as catalysts or photosensitive pigments are dispersed. The present invention also provides methods of encapsulation of suspensions in which not only alcohols, but also fluids with a relatively high dielectric constant are used as a dispersion medium.

According to a method for forming microcapsules in one embodiment of the present invention, suspensions in which microparticles are dispersed in a saturated alcohol dispersion medium may be prepared as a core material. Because saturated alcohol, which is not water or oil but a new material, is used as a dispersion medium, various kinds of dispersion media may be used and various response characteristics may be obtained from the application of the microcapsules. Thus, diverse and fine color expression may be achieved in the display fields.

In addition to superior processibility, excellent thermal stability, solvent resistance, and chemical stability may be achieved by using polyurea in microcapsules as a wall material according to one embodiment of the present invention.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for forming polyurea microcapsules, comprising:
dispersing microparticles in a saturated alcohol to prepare suspensions;
dissolving an amine-based monomer in the suspensions;
mixing and stirring suspensions with at least one selected from a vegetable oil and diesel oil to make emulsions; and
dissolving a non-polar isocyanate compound in the emulsions to prepare microcapsules having the suspensions as a core material.

2. The method of claim 1, wherein the microparticles include at least one selected from the group consisting of conductive particles, metal particles, organometallic particles, metal oxide particles, magnetic particles, and hydrophobic polymer particles.

3. The method of claim 1, wherein the saturated alcohol is at least one selected from the group consisting of methanol, ethanol, propargyl alcohol (C₃H₄O), aryl alcohol (C₃H₆O), propanol (C₃H₈O), glycerol, butanol, and alcohols having a dielectric constant ranging from 17 to 33.

4. The method of claim 1, wherein the dispersing of the microparticles in the saturated alcohol to prepare suspensions comprises adding a dispersion stabilizer into the saturated alcohol.

5. The method of claim 4, wherein the dispersion stabilizer is a surfactant or a hydrophilic polymer.

6. The method of claim 1, wherein the amine-based monomer is at least one selected from the group consisting of ethylenediamine (H₂NCH₂CH₂NH₂), triethylenetetramine (NH₂CH₂CH₂(NHCH₂CH₂)₂NH₂), piperazine, 1,6-hexamethylenediamine (H₂N—(CH₂)₆—NH₂), diethylenetetramine ((NH₂CH₂CH₂)₂NH), and polyethyleneimine (H(NHCH₂CH₂)nNH₂).

7. The method of claim 1, wherein the vegetable oil is at least one selected from the group consisting of canola oil, corn oil, sunflower seed oil, grape seed oil, and olive oil.

8. The method of claim 1, wherein the non-polar isocyanate compound is at least one selected from the group consisting of 2,4-tolylene diisocyanate (TDI), 4,4′-diphenylmethane diisocyanate (MDI), hexamethylene diisocyanate (HDI), and methylene bis(p-cyclohexyl isocyanate (H₁₂MDI).

9. The method of claim 1, wherein in the mixing and stirring of suspensions with the at least one selected from a vegetable oil and diesel oil to make an emulsion, the at least one selected from a vegetable oil and diesel oil is mixed at a volume ratio of from 5:1 to 10:1 with the suspensions.

10. A microcapsule, comprising:
suspensions as a core material, in which microparticles are dispersed in a saturated alcohol; and
polyurea as a wall material.

11. The microcapsule of claim 10, wherein the microparticles include at least one selected from the group consisting of conductive particles, metal particles, organometallic particles, metal oxide particles, magnetic particles, and hydrophobic polymer particles.

12. The microcapsule of claim 10, wherein the saturated alcohol is at least one selected from the group consisting of methanol, ethanol, propargyl alcohol (C₃H₄O), aryl alcohol (C₃H₆O), propanol (C₃H₈O), glycerol, butanol, and alcohols having a dielectric constant ranging from 17 to 33.
